(19) United States
(12) Patent Application Publication
(10) Pub. No.: US 2010/0125485 A1
(43) Pub. Date: May 20, 2010

(54) Interactive Selling System and Associated Methods

(76) Inventor: John Brian Bartels, Bethesda, MD (US)

Correspondence Address: DOUGLAS J. VISNIUS, 2519 ST. HEATHER WAY, ORLANDO, FL, 32806-5073, US

(21) Appl. No.: 12/273,890

(22) Filed: Nov. 19, 2008

(51) Int. Cl. G06Q 30/00

(52) U.S. Cl. 705/10; 705/1.1

(57) ABSTRACT

A system for interactive selling may include a data processing device and a human consumable product. The system may also include a concealed flavor associated with the human consumable product and a code carried by the human consumable product that by itself cannot reveal the concealed flavor to a consumer. The code and the data processing device may induce the consumer to purchase the human consumable product because the consumer can then relay the code to the data processing device which determines for the consumer the concealed flavor based upon the code.

### RELATED APPLICATION

This application is based upon, and claims priority from, co-pending Provisional Application No. 61/000,3789, filed Nov. 20, 2007, the entire subject matter of which is incorporated herein by reference in its entirety.

### FIELD OF THE INVENTION

The invention relates generally to the field of sales, and particularly to the area of sales systems.

### BACKGROUND OF THE INVENTION

The science of sales is highly developed. For example, U.S. Published Application No. 2004/0064357 to Hunter, et al. may disclose a system for new and experimental products for which no actual purchasing behavior is measurable, consumer behavior forecasting data is collected, and then corrected based on a comparison of forecasted versus actual measured behavioral data for existing “similar” products. The resulting corrected forecasts may more accurately reflect likely actual consumer behavior by taking into account errors inherent in the potential consumer survey process.

U.S. Pat. No. 5,090,734 to Dyer, et al. may disclose test panel members that receive a set of test materials including an evaluation set of products, a video tape containing a video presentation of members of the evaluation set, and means for ordering products free of charge. The choices made by the panel members may provide information as to preferences between test products and established brands.

U.S. Pat. No. 6,878,885 to Yung, et al. may disclose an apparatus for wireless purchase of merchandise from a vending machine by using a cellular mobile phone. The apparatus permits a cellular mobile phone user to dial a sequence of code on the phone to cause the vending machine to dispense merchandise and payment is charged to the mobile phone account. In addition, the apparatus may include a method for on-line inventory management.

U.S. Published Application No. 2006/0122881 to Walker, et al. may disclose a system for determining a mystery package, wherein the mystery package comprises a first mystery product and a second mystery product. In some embodiments, the first and second mystery products may be selected based at least in part on sales data associated with a plurality of products sold via a vending machine. Some embodiments may describe determining a price for the mystery package. Other embodiments may describe offering the mystery package for the determined mystery package price to a customer of the vending machine.

### SUMMARY OF THE INVENTION

It is an object of the invention to provide a new interactive selling system that differs from the prior art.

This and other objects, features, and advantages in accordance with the invention are provided by an interactive selling system that may include a data processing device and a human consumable product. The system may also include a concealed flavor associated with the human consumable product and a code carried by the human consumable product that by itself cannot reveal the concealed flavor to a consumer. The code and the data processing device may induce the consumer to purchase the human consumable product because the consumer can then relay the code to the data processing device which determines for the consumer the concealed flavor based upon the code.

The concealed flavor is unknown to the consumer at purchase time of the human consumable product and the code may be revealed to the consumer after the purchase time of the human consumable product. The code may also comprise coded data that includes flavor groups, allergy groups, store information, geographical information about purchase, promotional information, human consumable product production information, and/or the like.

The system may further include a production tracker in communications with the data processing device to generate human consumable product production information for a retailer. The system may also include a user ID associated with the consumer, and a user profile associated with the consumer. The user profile may be updated by the data processing device about which concealed flavor was experienced by the consumer when the user ID and the code are entered into the data processing device.

The system may also include a user interface that permits the consumer to enter the code into the data processing device, and a communications network in communication with the user interface. The communications network may comprise a short messenger service protocol. The user interface may comprise a cellular telephone, a computer, and/or the like.

The system may further comprise a product profile that groups the concealed flavor with related concealed flavors so the data processing device can provide such information to the consumer when the data processing device is queried by the consumer. The data processing device may comprise a cellular telephone, a computer, a kiosk, web server, and/or the like.

Another aspect of the invention is a method for interactive selling. The method may include associating a concealed flavor with a human consumable product and a code. The method may further include inducing the consumer to purchase the human consumable product by permitting the consumer to relay the code to a data processing device which then determines for the consumer the concealed flavor based upon the code.

The method may additionally comprise including coded data with the code that includes flavor groups, allergy groups, store information, geographical information about purchase, promotional information, human consumable product production information, and/or the like. The method may also include generating human consumable product production information for a retailer via a production tracker in communications with the data processing device.

The method may additionally comprise updating a user profile via the data processing device about which concealed flavor was experienced by the consumer when a user ID and the code are entered into the data processing device. The method may also include grouping the concealed flavor with related concealed flavors into a product profile so the data processing device can provide such information to the consumer when the data processing device is queried by the consumer.

### BRIEF DESCRIPTION OF THE DRAWINGS

FIG. 1 is a schematic block diagram of an interactive selling system in accordance with the invention.

FIG. 2 is a flowchart illustrating method aspects according to the invention.

FIG. 3 is a flowchart illustrating method aspects according to the method of FIG. 2.

FIG. 4 is a flowchart illustrating method aspects according to the method of FIG. 3.

FIG. 5 is a flowchart illustrating method aspects according to the method of FIG. 2.

FIG. 6 is a flowchart illustrating method aspects according to the method of FIG. 2.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

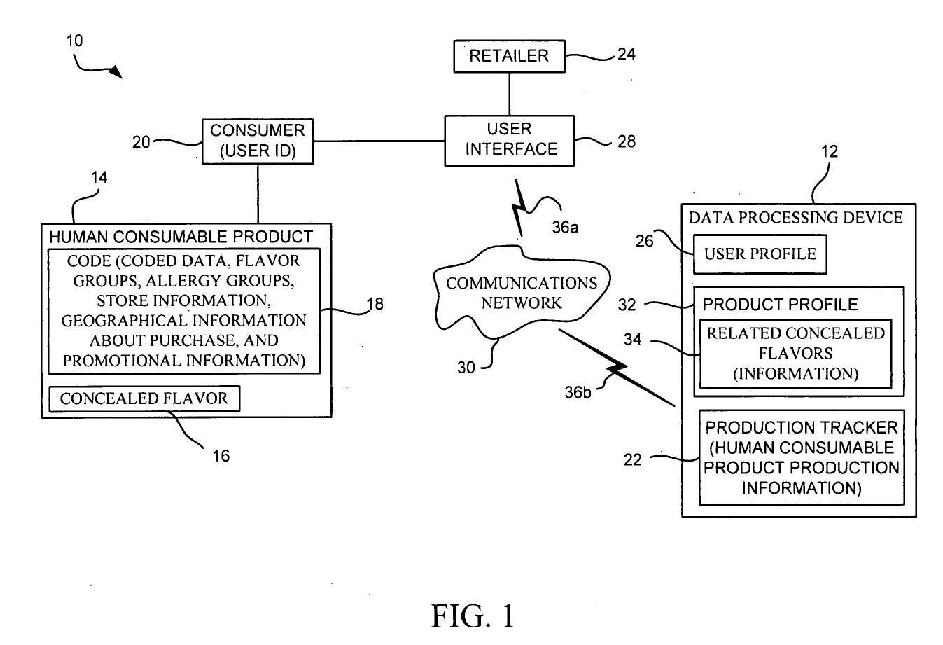

Referring to FIG. 1, a system 10 for interactive selling is initially described. The system 10 includes a data processing device 12 and a human consumable product 14, for example. The data processing device 12 comprises a cellular telephone, a computer, a kiosk, web server, and/or the like. The human consumable product 14 comprises food, beverage, and/or the like.

The system 10 also includes a concealed flavor 16 associated with the human consumable product 14 and a code 18 carried by the human consumable product that by itself cannot reveal the concealed flavor to a consumer 20, for instance. In one embodiment, the code 18 is applied to packaging in which the human consumable product 14 is wrapped.

The code 18 and the data processing device 12 induce the consumer 20 to purchase the human consumable product 14 because the consumer can then relay the code to the data processing device which determines for the consumer the concealed flavor 16 based upon the code, for example. Stated another way, the consumer 20 purchases the human consumable product 14 because they do not know the concealed flavor 16 of the human consumable product, but understand they can determine the concealed flavor if they enter the code 18 carried by the human consumable product into the data processing device 12.

In one embodiment, the concealed flavor 16 is unknown to the consumer 20 at purchase time of the human consumable product 14 and the code 18 is revealed to the consumer after the purchase time of the human consumable product. In another embodiment, the code 18 comprises coded data that includes flavor groups, allergy groups, store information, geographical information about purchase, promotional information, human consumable product production information, and/or the like. The coded data is an extension of the code 18 such as an extra digital or the like, for instance.

Allergy group coded data identifies potential commonly known allergic compounds such as peanuts, dairy, and/or the like for ease of discovery by the consumer 20 through communications with data processing device 12. Store information coded data identifies facts about the retail location to aid in management of a store selling the human consumable product 14. Geographical information about purchase coded data includes regional information about human consumable product 14 sales for a distributor, retailer, and/or the like of such. Promotional information coded data includes promotional information relayed to the consumer 20 via the data processing device 12 after entry of the code 18 to enhance the purchase experience of the consumer such as offering a discount on an additional purchase or the like.

The system 10 further includes a production tracker 22 in communications with the data processing device 12 to generate human consumable product production information for a retailer 24, for example. The human consumable product production information identifies what facility the human consumable product 14 was produced in, when the human consumable product was produced, and/or the like. The human consumable product production information aids a retailer and/or producer in the management, quality control, and/or the like of the human consumable product 14.

The system 10 includes a user ID associated with the consumer 20, and a user profile 26 associated with the consumer, for instance. In one embodiment, the user profile 26 is updated by the data processing device 12 about which concealed flavor 16 was experienced by the consumer 20 when the user ID and the code 18 are entered into the data processing device.

The system 10 also includes a user interface 28 that permits the consumer 20 to enter the code 18 into the data processing device 12, and a communications network 30 in communication with the user interface, for example. In one embodiment, the user interface 28 is an input and/or output combination for the data processing device 12.

In another embodiment, the communications network 30 comprises a short messenger service protocol. In yet another embodiment, the communications network 30 is a wired and/or wireless network including private and public communications infrastructure as well as internal communication infrastructure such as data buses, point-to-point links, and/or the like as will be appreciated by those of skill in the art.

The user interface 28 comprises a cellular telephone, a computer, and/or the like, for instance. In one embodiment, the various components of the system 10 use communication links 36a and 36b of the communications network 30 to communicate with each other as will be appreciated by those of skill in the art. In another embodiment, the system 10 includes additional data processing devices 12 and additional user interfaces 28 that are linked via the communications network 30 and that can be used by additional consumers 20 and retailers 24.

The system 10 further comprises a product profile 32 that groups the concealed flavor 16 with related concealed flavors 34 so the data processing device 12 can provide such information to the consumer 20 when the data processing device is queried by the consumer, for instance. In other words, the consumer 20 can interact with the data processing device 12 to determine what grouping of human consumable product 14 meets their criteria thereby further inducing the consumer to purchase the human consumable product.

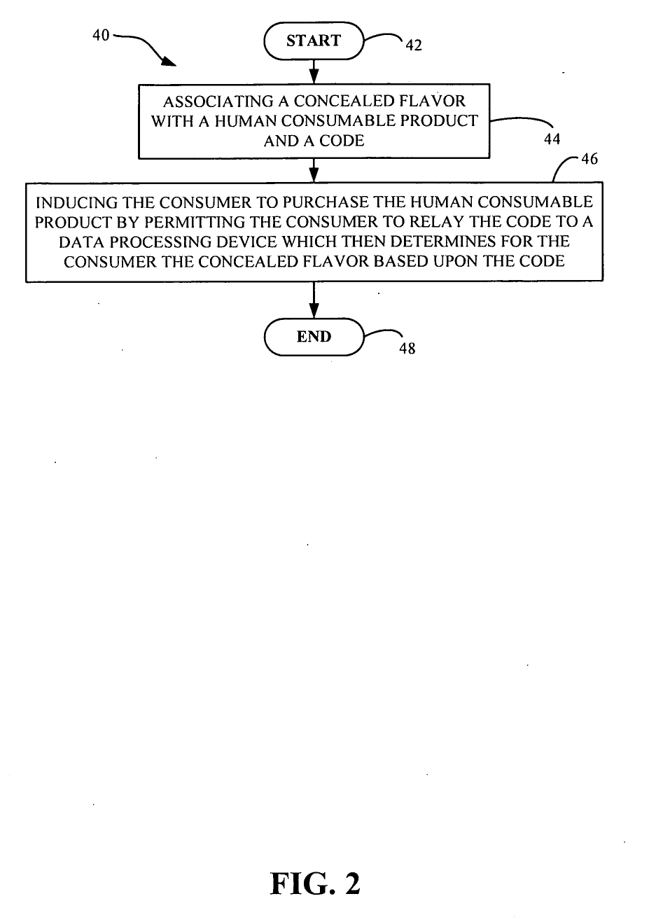

Another aspect of the invention is a method for interactive selling, which is now described with reference to flowchart 40 of FIG. 2. The method begins at Block 42 and may include associating a concealed flavor with a human consumable product and a code at Block 44. The method may also include inducing the consumer to purchase the human consumable product by permitting the consumer to relay the code to a data processing device which then determines for the consumer the concealed flavor based upon the code at Block 46. The method ends at Block 48.

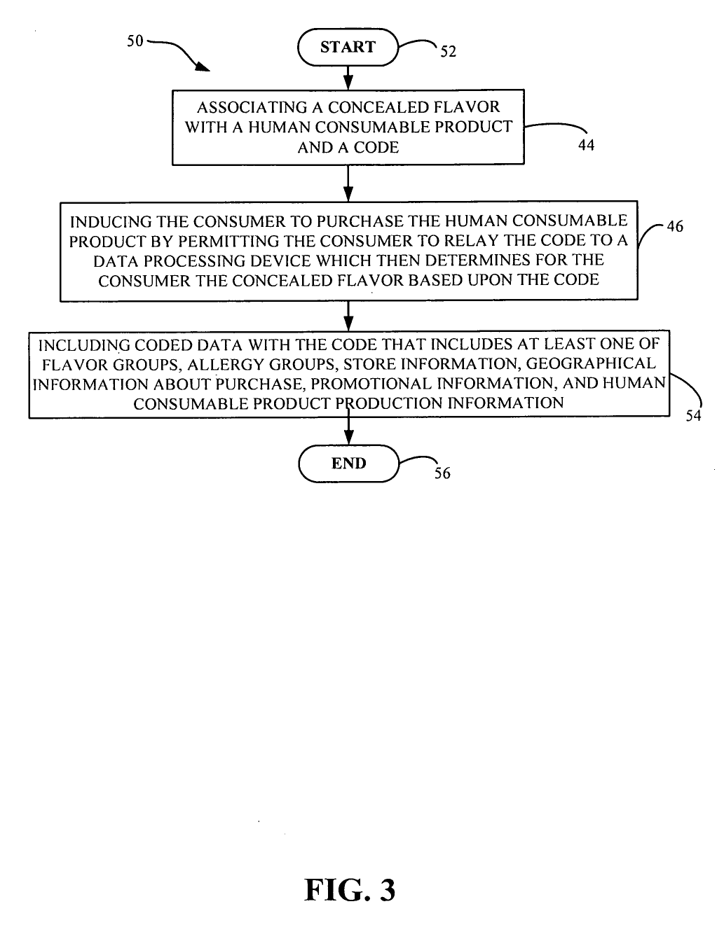

In another method embodiment, which is now described with reference to flowchart 50 of FIG. 3, the method begins at Block 52. The method may include the steps of FIG. 2 at Blocks 44 and 46. The method may additionally comprise including coded data with the code that includes flavor groups, allergy groups, store information, geographical information about purchase, promotional information, human consumable product production information, and/or the like at Block 54. The method ends at Block 56.

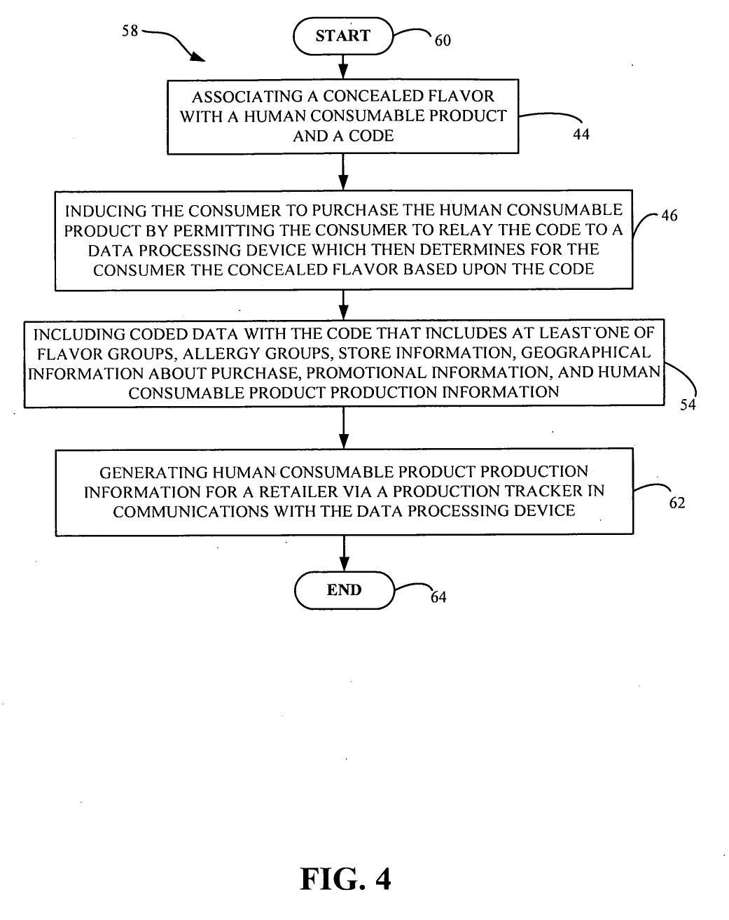

In another method embodiment, which is now described with reference to flowchart 58 of FIG. 4, the method begins at Block 60. The method may include the steps of FIGS. 2 and 3 at Blocks 44, 46, and 54, respectively. The method may further include generating human consumable product production information for a retailer via a production tracker in communications with the data processing device at Block 62. The method ends at Block 64.

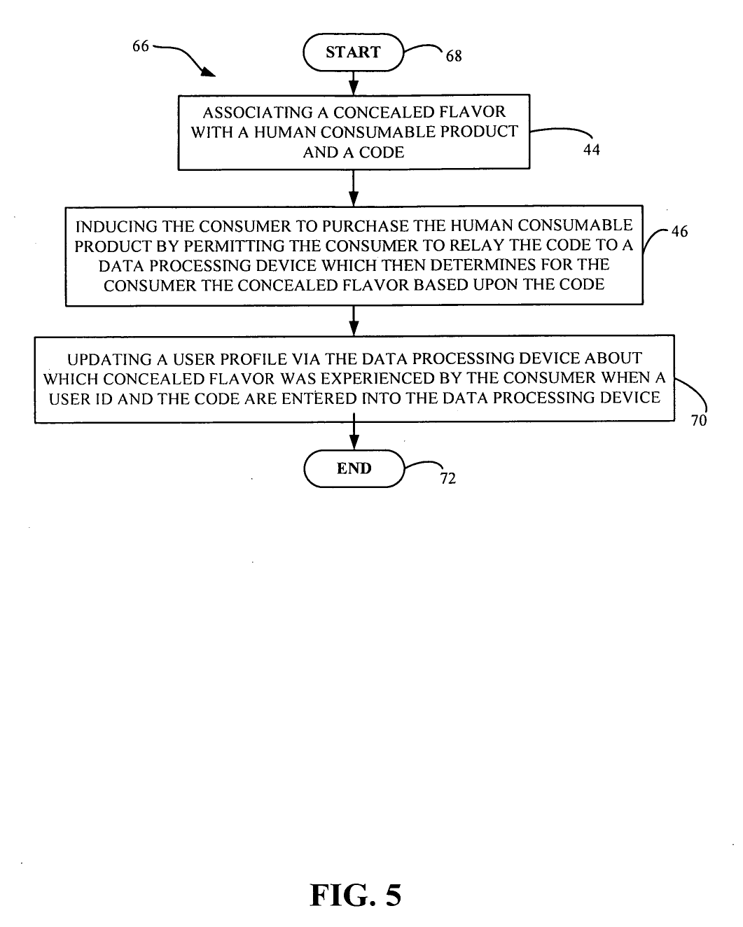

In another method embodiment, which is now described with reference to flowchart 66 of FIG. 5, the method begins at Block 68. The method may include the steps of FIG. 2 at Blocks 44 and 46. The method may additionally comprise updating a user profile via the data processing device about which concealed flavor was experienced by the consumer when a user ID and the code are entered into the data processing device at Block 70. The method ends at Block 72.

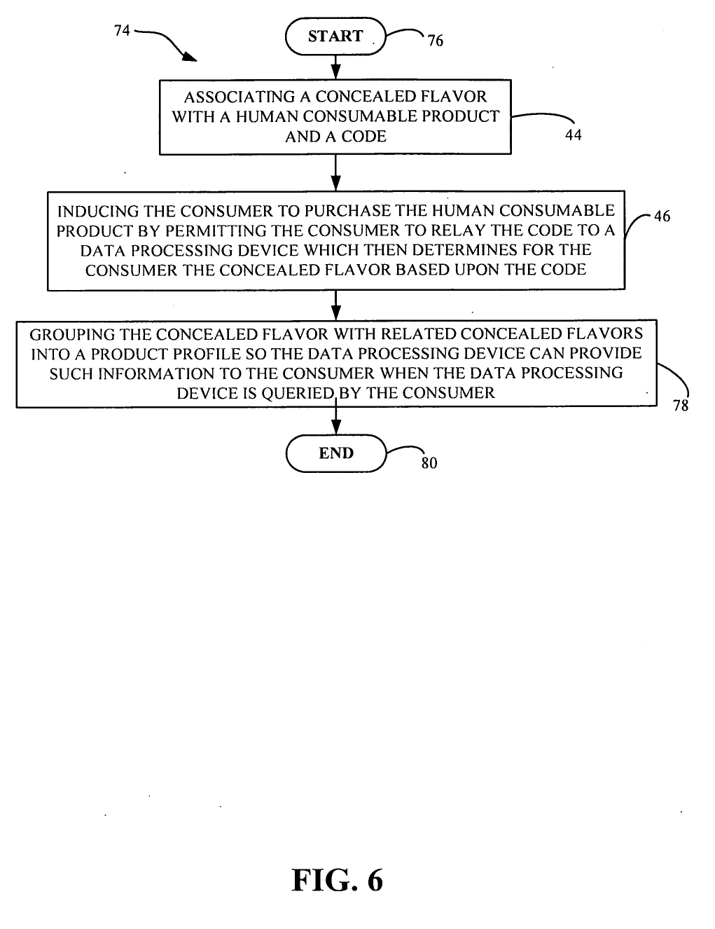

In another method embodiment, which is now described with reference to flowchart 74 of FIG. 6, the method begins at Block 76. The method may include the steps of FIG. 2 at Blocks 44 and 46. The method may also include grouping the concealed flavor with related concealed flavors into a product profile so the data processing device can provide such information to the consumer when the data processing device is queried by the consumer at Block 78. The method ends at Block 80.

A prophetic example of how the system 10 may work is now described. In this embodiment, the system 10 applies to sales of gelato, e.g. human consumable product 14, although the system can be used with other food, beverage, and non-food items where the product's characteristics are revealed through the use of the system 10.

More in particular, consumers 20 are always searching for novelties and games that are interesting and that will hold their attention. If a retailer 24 is successful at such, the new product will provide enjoyment for the consumers 20 and economic benefit for the retailer.

For instance, frozen desserts are a $20 billion market in the USA, but there really are no innovative products that capture the consumer 20's attention. The leader in frozen desserts, ice cream, is available in very predictable flavors. Gelato, with a lower fat content that allows for delicate and intense flavors, is offered in many restaurants and a relatively small number of shops.

One of the reasons for visiting a gelato shop is the opportunity to sample the various flavors. Consumers 20 often sample flavors that they have no intention of selecting for purchase because they are curious about an unusual flavor. Consumers 20 may be quite happy that they chose to only taste, but they can also be surprised by a new found favorite, and that is the fun. It is also typically a social experience as the consumer 20 has a taste and then tells their friends about it and perhaps goads them into trying it too.

The system 10 permits an interesting experience outside the gelato shop by combining a number of tastes of gelato in a single retail unit about the size of a candy bar. Each sample of the gelato, e.g. human consumable product 14, is individually wrapped and then a group of the samples would be wrapped together with very small spoons as the retail unit. To increase the fun and social aspects of the product containing the human consumable product 14, there would be no markings to indicate specific flavors on either the individual samples or on the retail unit package.

Instead there would be a code 18, e.g. five digit code, on each individual piece and on the outside of the retail unit packaging. These codes 18 would identify the concealed flavors 16 within. Typically, gelato or ice cream is packaged with one or two carefully matched flavors making the proposed packaging novel. This packaging is also not obvious as most companies want their customers to know what flavors are in the package so as not to disappoint. As a result, the system 10 is designed to surprise the customer 20 with interesting and unexpected flavors.

Since there are hundreds or thousands of flavors, the flavor selections within a retail unit are practically limitless. New flavor varieties will be introduced on a regular basis to maintain the fun and excitement for long time customers 20. Each of the new retail units may carry its own unique five digit code 18. Packaging of the assortments would also vary so that the selection of flavors could be grouped into known flavor groups such as chocolates, spices, Asian, tropical, sweet, bitter, savory, and/or the like in addition to assortments that have no boundaries.

The consumer 20 then learns the identity of the concealed flavor 16 or flavors by sending a message, e.g. a short message service (“SMS”) text message containing the code 18 through a communication network 30 to a data processing device 12 whose network address is noted on the outside of the retail unit. For instance, using an SMS text message creates a more useful product because the consumer 20 can interact easily and immediately with the product at the point of consumption regardless of their location, e.g. at home, at the beach, or the like.

SMS text messages are normally used for informal communication, voting on television shows, or the like, but not to interact with a consumer product. In system 10 the SMS text message sent by the consumer 20 contains the code 18 associated with the concealed flavor 16 and the SMS text message sent in response to such by the data processing device 12 identifies that flavor.

In one embodiment, if the consumer 20 sent a SMS text message with the code 18 for the retail unit, then the SMS text message response could be all of the concealed flavors 16 in the retail unit. In other embodiments, the consumer 20 would be free to send the SMS text message containing the code 18 before consuming or even purchasing the human consumable product 14 if they so chose.

In one embodiment, the data processing device 12 comprises a web site to accept the code 18 and respond with the concealed flavor 16 or flavors identified by that code. This offers the customer 20 an option to SMS text messages and an opportunity for the retailer 24 to enhance the customer-product relationship with additional interactivity which makes the human consumable product 14 more desirable to the consumer.

In another embodiment, the consumer 20 is able to register with the data processing device 12 web site. A user profile 26 accessed by the consumer 20 through the web site maintains a history of flavors tasted, flavor preferences, favorite flavor, and/or the like.

In one embodiment, the data processing device 12 web site is linked to a SMS text device (not shown) so that information would be shared between the user interface 28 and the data processing device web site. A consumer 20 who has registered and entered his/her cell phone number from which the SMS text messages are sent will have their SMS text messages entered into their flavor history within their user profile 26. This system of web site and SMS text messaging could be extended to provide, for example, a list of retail unit codes 18 already tried so the consumer 20 can choose a new flavor assortment, or the locations where the product is sold.

Additionally, at least one program storage device readable by a machine, tangibly embodying at least one program of instructions executable by the machine to perform the capabilities of the system 10 can be provided. The article of manufacture can be included as a part of a computer system or sold separately.

The capabilities of the system 10 can be implemented in software, firmware, hardware or some combination thereof.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention. Furthermore, the use of the terms a, an, etc. do not denote a limitation of quantity, but rather denote the presence of at least one of the referenced item.

That which is claimed is:

1. An interactive selling system comprising:
a data processing device;
a human consumable product;
a concealed flavor associated with said human consumable product; and
a code carried by said human consumable product that by itself cannot reveal said concealed flavor to a consumer;
said code and said data processing device induce the consumer to purchase said human consumable product because the consumer can relay said code to said data processing device which then determines for the consumer said concealed flavor based upon said code.

2. The system of claim 1 wherein said code further comprises coded data that includes at least one of flavor groups, allergy groups, store information, geographical information about purchase, promotional information, and human consumable product production information.

3. The system of claim 2 further comprising a production tracker in communications with said data processing device to generate human consumable product production information for a retailer.

4. The system of claim 1 further comprising:
a user ID associated with the consumer; and
a user profile associated with the consumer;
said user profile updated by said data processing device about which concealed flavor was experienced by the consumer when said user ID and said code are entered into said data processing device.

5. The system of claim 1 further comprising:
a user interface to permit the consumer to enter said code into said data processing device; and
a communications network in communication with said user interface.

6. The system of claim 5 wherein said communications network comprises a short messenger service protocol.

7. The system of claim 5 wherein said user interface comprises at least one of a cellular telephone, and a computer.

8. The system of claim 1 wherein said concealed flavor is unknown to the consumer at purchase time of said human consumable product and said code is revealed to the consumer after the purchase time of said human consumable product.

9. The system of claim 1 further comprising a product profile that groups said concealed flavor with related concealed flavors so said data processing device can provide such information to the consumer when said data processing device is queried by the consumer.

10. The system of claim 1 wherein said data processing device comprises at least one of a cellular telephone, a computer, and a kiosk.

11. A method for interactive selling comprising:
associating a concealed flavor with a human consumable product and a code; and
inducing the consumer to purchase the human consumable product by permitting the consumer to relay the code to a data processing device which then determines for the consumer the concealed flavor based upon the code.

12. The method of claim 11 further comprising including coded data with the code that includes at least one of flavor groups, allergy groups, store information, geographical information about purchase, promotional information, and human consumable product production information.

13. The method of claim 12 further comprising generating human consumable product production information for a retailer via a production tracker in communications with the data processing device.

14. The method of claim 11 further comprising updating a user profile via the data processing device about which concealed flavor was experienced by the consumer when a user ID and the code are entered into the data processing device.

15. The method of claim 11 wherein the concealed flavor is unknown to the consumer at purchase time of the human consumable product and the code is fully revealed to the consumer after the purchase time of the human consumable product.

16. The method of claim 11 further comprising grouping the concealed flavor with related concealed flavors into a product profile so the data processing device can provide such information to the consumer when the data processing device is queried by the consumer.

17. An interactive selling system comprising:
a data processing device;
a human consumable product;
a concealed flavor associated with said human consumable product;
a code carried by said human consumable product that by itself cannot reveal said concealed flavor to a consumer; and
a product profile that groups said concealed flavor with related concealed flavors so said data processing device can provide such information to the consumer when said data processing device is queried by the consumer;
said code and said data processing device used to induce the consumer to purchase said human consumable product because the consumer can relay said code to said data processing device which then determines for the consumer said concealed flavor based upon said code, and said concealed flavor is unknown to the consumer at purchase time of said human consumable product and said code is revealed to the consumer after the purchase time of said human consumable product.

18. The system of claim 17 wherein said code further comprises coded data that includes at least one of flavor groups, allergy groups, store information, geographical information about purchase, promotional information, and human consumable product production information.

19. The system of claim 18 further comprising a production tracker in communications with said data processing device to generate human consumable product production information for a retailer.

20. The system of claim 17 further comprising:
a user ID associated with the consumer; and
a user profile associated with the consumer;
said user profile updated by said data processing device about which concealed flavor was experienced by the consumer when said user ID and said code are entered into said data processing device.
